(19) United States
(12) Patent Application Publication
(10) Pub. No.: US 2008/0171517 A1
(43) Pub. Date: Jul. 17, 2008

(54) Radio signal analysis

(76) Inventors: Isaac Ali, Bristol (GB); David Albert Sawyer, Swindon (GB); Nick Cowley, Wiltshire (GB)

Correspondence Address: CAVEN & AGHEVLI;c/o INTELLEVATE, LLC, P.O. BOX 52050, MINNEAPOLIS, MN, 55402, US

(21) Appl. No.: 11/648,849

(22) Filed: Dec. 29, 2006

(51) Int. Cl. G01S 7/40; H04B 17/00

(52) U.S. Cl. 455/67.14

(57) ABSTRACT

In some embodiments, a radio transmitter assembly comprises a test signal generator module to generate a first instance of a test signal, the test signal comprising a code, a test signal receiver module which receives the code, a signal combiner to combine the first instance of the test signal with a real signal to create a combined signal, a radio signal generator to generate a radio signal from the combined signal, a signal separator to separate a second instance of the test signal from the radio signal, and comparator logic in the test signal receiver module to compare the code with a code embedded in the second instance of the test signal in the test signal receiver module.

### BACKGROUND

The subject matter described herein relates generally to the field of electronic devices and more particularly to radio signal analysis.

In wireless mobile radio communication, there is a desire for increased capacity and improved quality. Today's portable communication products such as cellular telephones and laptop computers require reception of an accurate data stream at a high data rate for effective operation. To reduce crosstalk in a radio architecture, sources of interference such as, e.g., gain imbalance and filter imbalances should be monitored and reduced.

### BRIEF DESCRIPTION OF THE DRAWINGS

The detailed description is described with reference to the accompanying figures.

FIG. 1 is a schematic illustration of a radio signal processor assembly in accordance with some embodiments.

FIG. 2 is a flowchart illustrating aspects of a method for radio signal analysis, in accordance with some embodiments.

FIG. 3 is a schematic illustration of an architecture of a computer system in accordance with some embodiments.

### DETAILED DESCRIPTION

Described herein are exemplary systems and methods for radio signal analysis which may be used in, e.g., computing devices or communication devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In some embodiments, a test signal may be placed in the same spectrum as the radio signal in such a way that the test signal will not interfere with the radio signal. The test signal is separated from the desired signal at the output of the radio signal generator (i.e., the radio receiver) where it can be compared against the original test signal to determine signal impairments created by the radio architecture. The test signal may be generated locally (i.e., on chip) and therefore all the required timing information as well as the original test code is available for demodulation purposes.

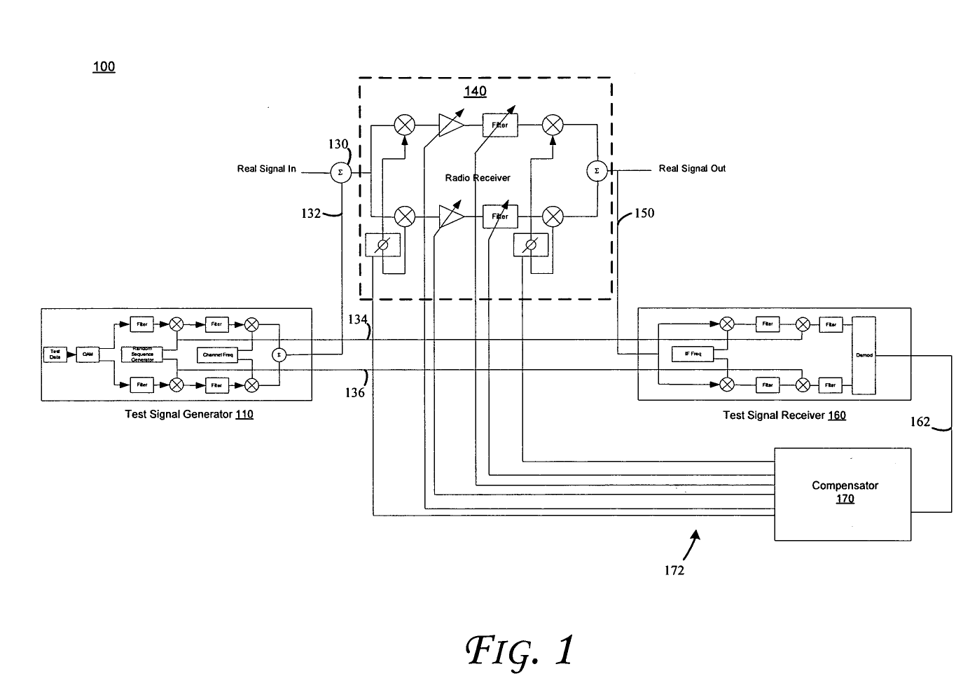

FIG. 1 is a schematic illustration of a radio signal processor assembly 100 in accordance with some embodiments. Referring to FIG. 1, radio signal processor assembly 100 comprises a test signal generator 110, which generates a first instance of a test signal. In some embodiments the test signal transmitter 110 comprises a random sequence generator to generate a random character sequence, which is used to modulate a code using a modulation scheme such as, e.g., quadrature amplitude modulation (QAM). In some embodiments the random sequence generator may generate a single random sequence, which may be input to both the in-phase signal component modulator and the quadrature signal component modulator. In some embodiments the random sequence generator may generate a first random sequence for the in-phase signal component modulator and a second random sequence for the quadrature signal component modulator.

Radio signal processor assembly 100 comprises a bus 132 coupled to test signal generator 110 and to a signal combiner 130, which combines the test signal with a real signal to create a combined signal. Bus 132 carries the test signal generated by test signal generator 110 to signal combiner 130. Radio signal processor assembly 100 further comprises a busses 134 and 136 coupled to the output(s) of the random sequence generator in test signal generator 110. Busses 134, 136 carry he random sequence(s) from the test signal generator 110 to a test signal receiver 160.

Assembly 100 further comprises a radio receiver 140 to process a radio signal from the combined signal. In some embodiments radio signal processor 140 may make use of frequency translation by way of quadrature up or down conversion. Transmitter assembly 100 comprises a bus 150 which couples the output of radio signal generator 140 to test signal receiver 160.

Test signal receiver 160 demodulates the output of radio signal generator 140 to separate a second copy of the test signal from the radio signal generated by radio signal processor 140. Test signal receiver uses the random sequence(s) received on busses 134, 136 to demodulate the output of radio signal generator 140.

Bus 162 carries the output of test signal receiver to a compensator module 170. Radio signal processor assembly 100 further comprises a compensator 170. Compensator 170 comprises a signal separator to separate a second instance of the test signal from the radio signal and comparator logic in the test signal receiver module to compare the code with a code embedded in the second instance of the test signal in the test signal receiver module. Compensator 170 may further comprise logic to generate at least one compensation signal and logic to transmit the compensation signal to the radio receiver module 140, e.g., over busses 172. Radio receiver 140 may use the compensation signals to tune the receiver to remove signal perturbations introduced by the circuitry of radio receiver 140.

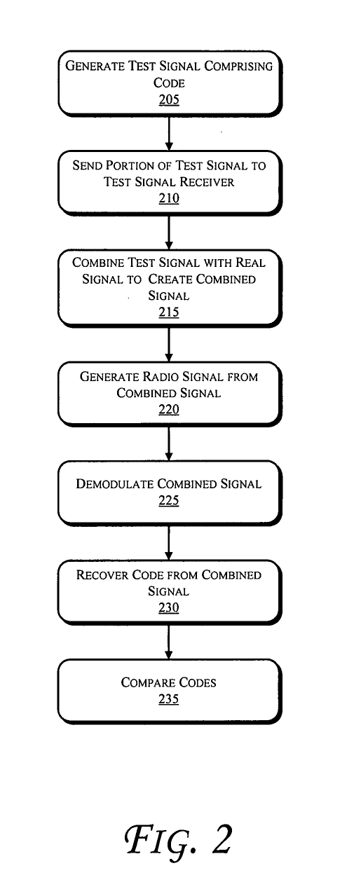

FIG. 2 is a flowchart illustrating aspects of a method for radio signal analysis, in accordance with some embodiments. Referring to FIG. 2, at operation 205 a test signal is generated, e.g., by test signal generator 110. At operation 210 a portion of the test signal is sent to the test signal receiver 160. In the embodiment depicted in FIG. 1, the output(s) of the random sequence generator is sent to the test signal receiver 160 via busses 134, 136.

At operation 215 the test signal is combined with a real signal to create a combined signal. In the embodiment depicted in FIG. 1 the test signal generated on bus 132 is combined with a real signal in signal combiner 130. At operation 220 a radio signal is generated from the combined signal. In the embodiment depicted in FIG. 1 the radio receiver 140 generates a radio signal from the combined signal.

At operation 225 the combined signal is demodulated. In the embodiment depicted in FIG. 1 the combined signal is input to test signal receiver 160, which demodulates the combined signal. At operation 230 the code embedded in the combined signal is recovered from the combined signal, and at operation 235 the code recovered from the combined signal is compared with the code embedded in the test signal generated by test signal generator 110. Differences between the codes are detected, and may be considered indicative of errors introduced into the signal by the circuitry of radio receiver 140. Radio receiver 140 will apply the same errors to the real signal input to radio receiver 140.

Differences between the codes may be used to generate one or more compensation signals, which may be provided as feedback to radio receiver 140. Thus, in operation the transmitter assembly 100 provides a feedback loop which permits a radio receiver to dynamically adjust one or more components to reduce errors in the output of radio receiver.

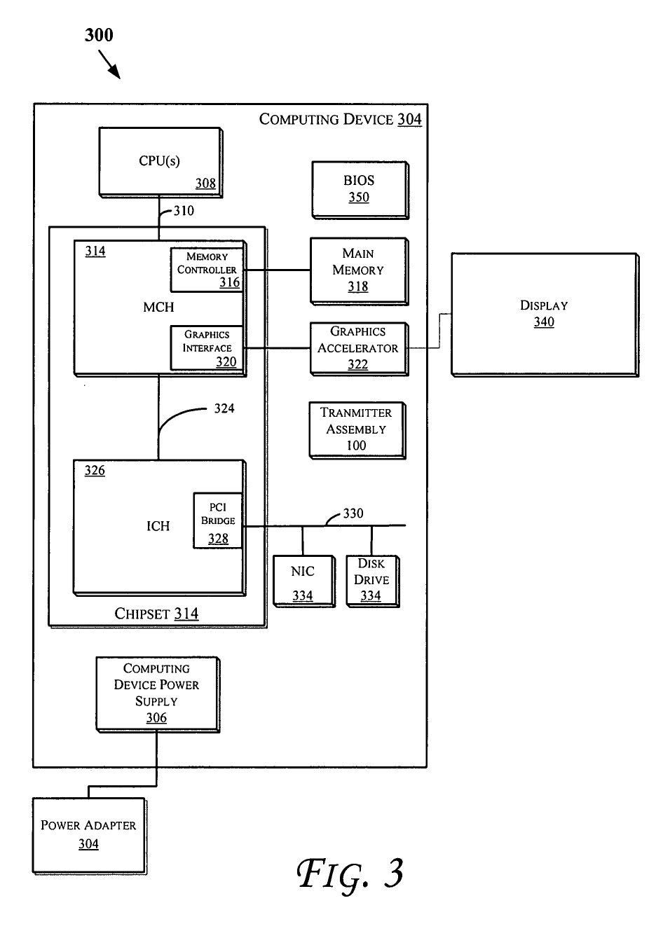

In some embodiments the radio transmitter assembly 100 depicted in FIG. 1 may be incorporated into an integrated circuit, which may be incorporated into a computer system. FIG. 3 is a schematic illustration of an architecture of a computer system in accordance with some embodiments. Computer system 300 includes a computing device 302 and a power adapter 304 (e.g., to supply electrical power to the computing device 302). The computing device 302 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 302 (e.g., through a computing device power supply 306) from one or more of the following sources: one or more battery packs, an alternating current (AC) outlet (e.g., through a transformer and/or adaptor such as a power adapter 304), automotive power supplies, airplane power supplies, and the like. In one embodiment, the power adapter 304 may transform the power supply source output (e.g., the AC outlet voltage of about 110 VAC to 240 VAC) to a direct current (DC) voltage ranging between about 7 VDC to 12.6 VDC. Accordingly, the power adapter 304 may be an AC/DC adapter.

The computing device 302 may also include one or more central processing unit(s) (CPUs) 308 coupled to a bus 310. In one embodiment, the CPU 308 may be one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 312 may be coupled to the bus 310. The chipset 312 may include a memory control hub (MCH) 314. The MCH 314 may include a memory controller 316 that is coupled to a main system memory 318. The main system memory 318 stores data and sequences of instructions that are executed by the CPU 308, or any other device included in the system 300. In some embodiments, the main system memory 318 includes random access memory (RAM); however, the main system memory 318 may be implemented using other memory types such as dynamic RAM (DRAM), synchronous DRAM (SDRAM), and the like. Additional devices may also be coupled to the bus 310, such as multiple CPUs and/or multiple system memories.

In some embodiments, main memory 318 may include a one or more flash memory devices. For example, main memory 318 may include either NAND or NOR flash memory devices, which may provide hundreds of megabytes, or even many gigabytes of storage capacity.

The MCH 314 may also include a graphics interface 320 coupled to a graphics accelerator 322. In one embodiment, the graphics interface 320 is coupled to the graphics accelerator 322 via an accelerated graphics port (AGP). In an embodiment, a display (such as a flat panel display) 340 may be coupled to the graphics interface 320 through, for example, a signal converter that translates a digital representation of an image stored in a storage device such as video memory or system memory into display signals that are interpreted and displayed by the display. The display 340 signals produced by the display device may pass through various control devices before being interpreted by and subsequently displayed on the display.

A hub interface 324 couples the MCH 314 to an input/output control hub (ICH) 326. The ICH 326 provides an interface to input/output (I/O) devices coupled to the computer system 300. The ICH 326 may be coupled to a peripheral component interconnect (PCI) bus. Hence, the ICH 326 includes a PCI bridge 328 that provides an interface to a PCI bus 330. The PCI bridge 328 provides a data path between the CPU 308 and peripheral devices. Additionally, other types of I/O interconnect topologies may be utilized such as the PCI Express™ architecture, available through Intel® Corporation of Santa Clara, Calif.

The PCI bus 330 may be coupled to a network interface card (NIC) 332 and one or more disk drive(s) 334. Other devices may be coupled to the PCI bus 330. In addition, the CPU 308 and the MCH 314 may be combined to form a single chip. Furthermore, the graphics accelerator 322 may be included within the MCH 314 in other embodiments.

Additionally, other peripherals coupled to the ICH 326 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

System 300 may further include a basic input/output system (BIOS) 350 to manage, among other things, the boot-up operations of computing system 300. BIOS 350 may be embodied as logic instructions encoded on a memory module such as, e.g., a flash memory module.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system, comprising:
a display;
a test signal generator module to generate a first instance of a test signal, the test signal comprising a code;
a test signal receiver module to receive the code;
a signal combiner to combine the first instance of the test signal with a real signal to create a combined signal;
a radio signal generator to generate a radio signal from the combined signal;
a signal separator to separate a second instance of the test signal from the radio signal; and
comparator logic to compare the code with a code embedded in the second instance of the test signal in the test signal receiver module.

2. The system of claim 1, wherein the test signal generator is operative to modulate the code with a random sequence.

3. The system of claim 1, further comprising logic to up-convert the first instance of the test signal before the first instance of the test signal is sent to the test signal receiver module.

4. The system of claim 1, wherein the test signal generator is operative to generate I and Q signal components.

5. The system of claim 1, wherein the comparator logic in the test signal receiver detects at least one difference between the code and the embedded signal in the second instance of the test signal.

6. The system of claim 5, further comprising:
logic to generate at least one compensation signal; and
logic to transmit the compensation signal to a radio transceiver.

7. A radio transmitter assembly, comprising:
a test signal generator module to generate a first instance of a test signal, the test signal comprising a code;
a test signal receiver module to receive the code;
a signal combiner to combine the first instance of the test signal with a real signal to create a combined signal;
a radio signal generator to generate a radio signal from the combined signal;
a signal separator to separate a second instance of the test signal from the radio signal; and
comparator logic to compare the code with a code embedded in the second instance of the test signal in the test signal receiver module.

8. The radio transmitter assembly of claim 7, wherein the test signal generator is operative to modulate the code with a random sequence.

9. The radio transmitter assembly of claim 7, further comprising logic to up-convert the first instance of the test signal before the first instance of the test signal is sent to the test signal receiver module.

10. The radio transmitter assembly of claim 9, wherein the test signal generator is operative to generate I and Q signal components.

11. The radio transmitter assembly of claim 9, wherein the comparator logic in the test signal receiver detects at least one difference between the code and the embedded signal in the second instance of the test signal.

12. The radio transmitter assembly of claim 13, further comprising:
logic to generate at least one compensation signal; and
logic to transmit the compensation signal to a radio transceiver.

13. A method, comprising:
generating a first instance of a test signal, the test signal comprising a test signal code;
sending a portion of the test signal to a test signal receiver module;
combining the first instance of the test signal with a real signal to create a combined signal;
generating a radio signal from the combined signal;
demodulating the combined signal;
recovering a code embedded in the combined signal; and
comparing the test signal code with the code embedded in the second instance of the test signal in the test signal receiver module.

14. The method of claim 13, wherein generating a first instance of a test signal comprises modulating the code with a random sequence.

15. The method of claim 13, further comprising up-converting the first instance of the test signal before sending the first instance of the test signal to a test signal receiver module.

16. The method of claim 13, wherein generating a first instance of a test signal comprises generating I and Q signal components.

17. The method of claim 13, further comprising detecting at least one difference between the test signal code and the code embedded in the second instance of the test signal.

18. The method of claim 13, further comprising:
generating at least one compensation signal; and
transmitting the compensation signal to a radio transceiver.
